(19) United States
(12) Patent Application Publication
(10) Pub. No.: US 2010/0205773 A1
(43) Pub. Date: Aug. 19, 2010

(54) SWING HINGE APPARATUS OF CELLULAR PHONE

(75) Inventor: Deok-Seon Kim, Incheon (KR)

Correspondence Address: LADAS & PARRY, 5670 WILSHIRE BOULEVARD, SUITE 2100, LOS ANGELES, CA, 90036-5679, US

(73) Assignee: DIABELL CO., LTD., Gyeonggi-do (KR)

(21) Appl. No.: 12/670,101

(22) PCT Filed: Jul. 23, 2008
(86) PCT No.: PCT/KR2008/004295

§ 371 Date: Jan. 21, 2010

(30) Foreign Application Priority Data
Jul. 24, 2007 (KR) 10-2007-0073989

(51) Int. Cl. E05F 1/12; E05D 5/02; E05D 11/00; E05D 5/10

(52) U.S. Cl. 16/250; 16/387; 16/277

(57) ABSTRACT

A swing hinge apparatus of a cellular phone according to the present invention includes: a plurality of first and second lower magnets having polarities different from each other; a lower casing, the first and second lower magnets being respectively inserted into one surface of the lower casing; a plurality of first and second upper magnets having the same polarities as the first and second lower magnets respectively; and a rotating plate provided over the lower casing, where the first and second upper magnets are respectively inserted into one surface thereof facing the lower casing.

### TECHNICAL FIELD

The present invention relates to a swing hinge apparatus of a cellular phone, and more particularly, to a swing hinge apparatus of a cellular phone using magnetic force.

### BACKGROUND ART

Generally, a portable wireless terminal includes a bar type, a flip type, a flip-up type, a folder type, a slide type or a landscape type terminals. The type of the portable wireless terminal has been changed according to the time when it is used.

In the folder type terminal, upper and lower bodies of the terminal are connected to each other through a shaft and the lower body is opened or closed by rotating the upper body about the shaft. In the landscape type terminal, a display unit is horizontally rotated by rotating the shaft, or the display unit itself is horizontally rotated.

On the other hand, there is a slider module that can provide landscape function by enabling a slider of a screen to move vertically/horizontally so that the slider type terminal can perform a landscape function for playing a game or watching TV.

However, the above swing type terminal has a problem that the lifetime is shortened by abrasion due to friction between coupling portions of the swing hinge apparatus.

### DISCLOSURE OF INVENTION

### Technical Problem

Accordingly, an object of the present invention is to provide a swing hinge apparatus that is swung by magnetic force.

Additional objects of the invention will be set forth the description and accompanying drawings which follow.

### Technical Solution

According to an aspect of the present invention, there is provided a swing hinge apparatus of a cellular phone, which includes: a plurality of first and second lower magnets having polarities different from each other; a lower casing, the first and second lower magnets being respectively inserted into one surface of the lower casing; a plurality of first and second upper magnets having the same polarities as the first and second lower magnets respectively; and a rotating plate provided over the lower casing, where the first and second upper magnets are respectively inserted into one surface thereof facing the lower casing.

The rotating plate may move to first and second positions by rotation and, at the first position, the each first upper magnet may be located over the each second lower magnet and the each second upper magnet may be located over the each first lower magnet while at the second position, the each first upper magnet may be located over the each first lower magnet and the each second upper magnet may be located over the each second lower magnet.

The rotating plate may move to first and second positions by rotation and, at the first position, the each first upper magnet may be located over the each second lower magnet and the each second upper magnet may be located over the each second lower magnet while at the second position, the each first upper magnet may be located over the each first lower magnet and the each second upper magnet may be located over the each first lower magnet.

The first and second upper magnets may be alternatively arranged to be equiangular to each other about a rotation center of the rotating plate and the first and second lower magnets may be alternatively arranged to be equiangular to each other about the rotation center of the rotating plate.

The swing hinge apparatus may further include an upper casing that is provided over the lower casing so as to surround the edge of the rotating plate.

The swing hinge apparatus may further include a shaft that is located at the rotation center of the rotating plate and connects the rotating plate to the lower casing, and an elastic body that is provided on the shaft and above the rotating plate and provides elastic force toward the lower casing.

The lower casing may include a cam surface and a plurality of cam grooves concaved from the cam surface, and the rotating plate may include a cam projection that moves along the cam surface and is inserted into any one of the cam grooves at the first and second positions.

The swing hinge apparatus may further include a lower shielding member provided between the lower casing and the first and second lower magnets in order to shield magnetic force of the first and second lower magnets; and an upper shielding member provided between the rotating plate and the first and second upper magnets in order to shield magnetic force of the first and second upper magnets.

### ADVANTAGEOUS EFFECTS

The swing hinge apparatus according to the present invention produces following effects.

First, the swing hinge apparatus is swung with minimum friction force between elements by using magnetic force, thereby preventing abrasion caused by friction. Thus, durability of the swing hinge apparatus is improved.

Second, the magnets of the rotating plate and the magnets of the lower casing are arranged to have the same and different polarities alternatively. Accordingly, magnetic force is uniformly generated when the rotating plate is rotated and the rotating plate and lower casing are constantly kept to be spaced from each other. Thus, the semi-permanent swing hinge apparatus can be realized by preventing friction between the rotating plate and lower casing.

### BRIEF DESCRIPTION OF THE DRAWINGS

FIG. 1 is a perspective view illustrating a swing hinge apparatus according to the present invention;

FIG. 2 is an exploded perspective view illustrating the swing hinge apparatus of FIG. 1;

FIG. 3 is a sectional view illustrating the swing hinge apparatus of FIG. 1;

FIGS. 4 to 6 are views illustrating operations of a rotating plate and a lower casing of FIG. 1;

FIG. 7 is a view illustrating a swing hinge apparatus according to another embodiment of the present invention; and

FIG. 8 is a view illustrating a swing hinge apparatus according to a still another embodiment of the present invention.

### BEST MODE FOR CARRYING OUT THE INVENTION

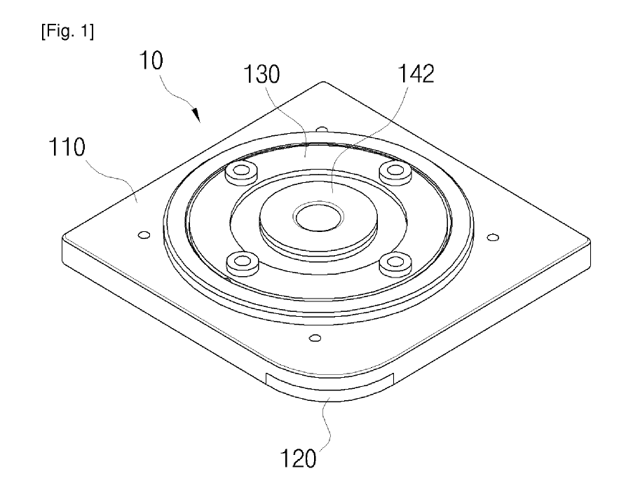

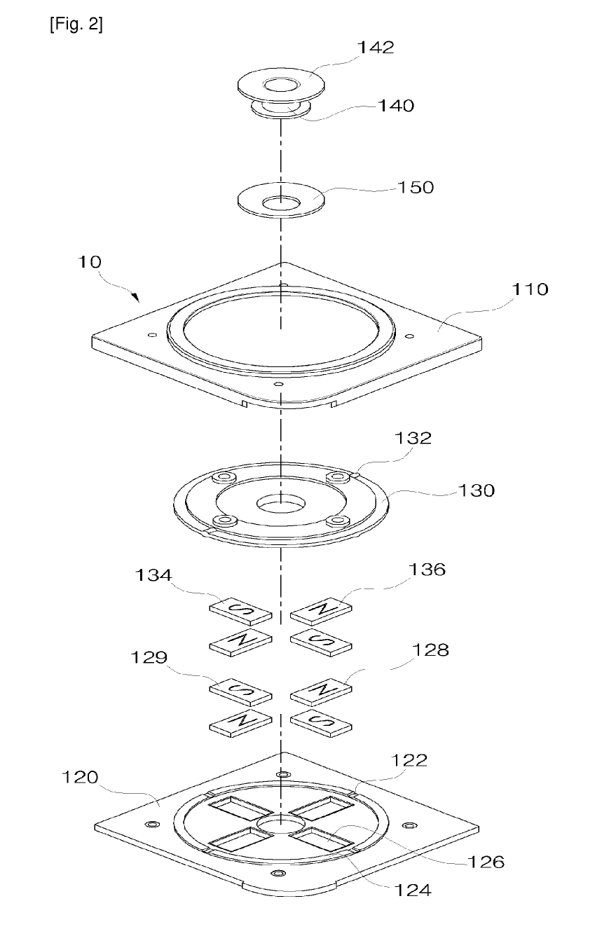

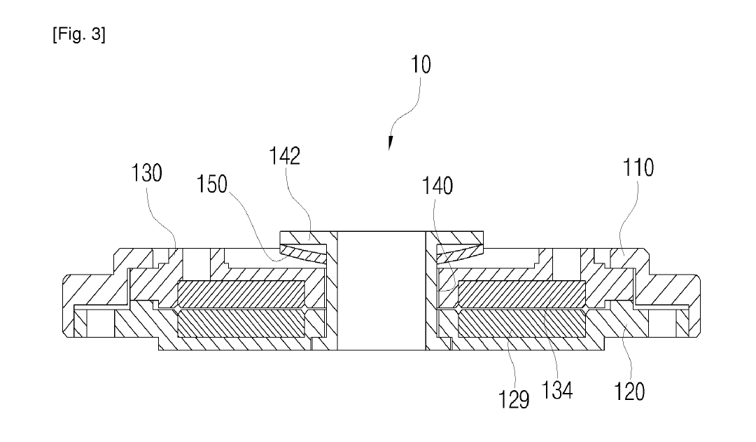

FIG. 1 is a perspective view illustrating a swing hinge apparatus according to the present invention and FIG. 2 is an exploded perspective view illustrating the swing hinge apparatus of FIG. 1 and FIG. 3 is a sectional view illustrating the swing hinge apparatus of FIG. 1.

Referring to FIGS. 1 to 3, a swing hinge apparatus 10 includes an upper casing 110, a lower casing 120, a rotating plate 130, a shaft 140 and an elastic body 150. The rotating plate 130 is combined to the lower casing 120 through the shaft 140 located at a rotation center of the rotating plate 130 and rotates about the shaft 140 over the lower casing 120. The shaft 140 includes a hook piece 142 to prevent the rotating plate 130 from being separated from the lower casing 120. As shown in FIG. 3, an upper end of the elastic body 150 is contacted to the hook piece 142 and a lower end thereof is contacted to an upper surface of the rotating plate 130. The elastic body 150 provides elastic force to the rotating plate 130 in the direction toward the lower casing 120.

First and second lower magnets 129 and 128 are inserted into the upper surface of the lower casing 120 and first and second upper magnets 134 and 136 are inserted into the lower surface of the rotating plate 130. In this time, the first and second lower magnets 129 and 128 have different polarities from each other and the first upper magnet 134 has the same polarity as the first lower magnet 129 and the second upper magnet 136 has the same polarity as the second lower magnet 128.

In addition, the first and second lower magnets 129 and 128 are alternatively arranged to be equiangular (for example, 90°) to each other about the rotation center of the rotating plate 130 and the first and second upper magnets 134 and 136 are alternatively arranged to be equiangular (for example, 90°) to each other about the rotation center of the rotating plate 130.

On the other hand, the upper casing 110 is combined with the lower casing 120. As shown in FIG. 3, the upper casing 110 surrounds the edge of the rotating plate 130 in a state that the upper casing 110 is combined with the lower casing 120.

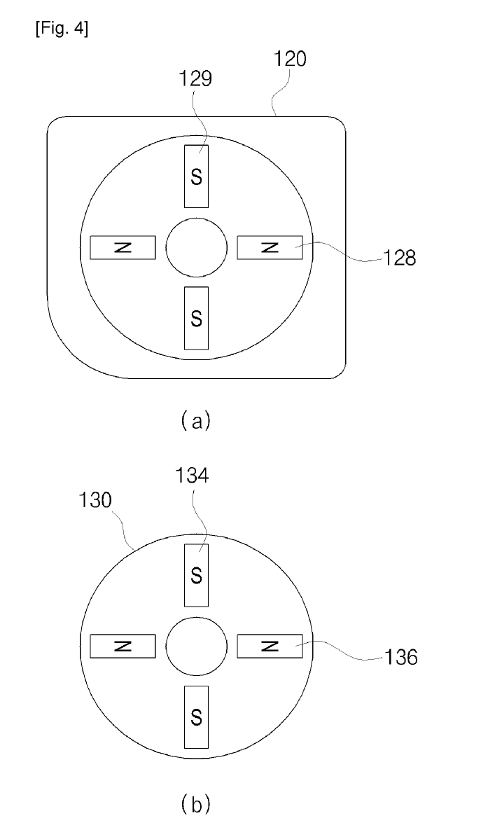

FIGS. 4 to 6 are views illustrating operations of the rotating plate 130 and lower casing 120 of FIG. 1. The operations of the rotating plate 130 and lower casing 120 will be explained below with reference to FIGS. 4 to 6.

FIG. 4(a) shows an upper surface of the lower casing 120 provided with the first and second lower magnets 129 and 128 and FIG. 4(b) shows a lower surface of the upper casing 110 provided with the first and second upper magnets 134 and 136. As shown in FIG. 4, when the rotating plate 130 is located at the first position, the first upper magnet 134 is located over the first lower magnet 129 and the second upper magnet 136 is located over the second lower magnet 128. In this time, the first upper magnet 134 and first lower magnet 129 have the same polarity and the second upper magnet 136 and second lower magnet 128 have the same polarity. Accordingly, repulsive force is generated between the first upper magnet 134 and first lower magnet 129, and between the second upper magnet 136 and second lower magnet 128. The repulsive force helps the rotating plate 130 to rotate easily. The rotating plate 130 rotates about the rotation center of the rotating plate 130.

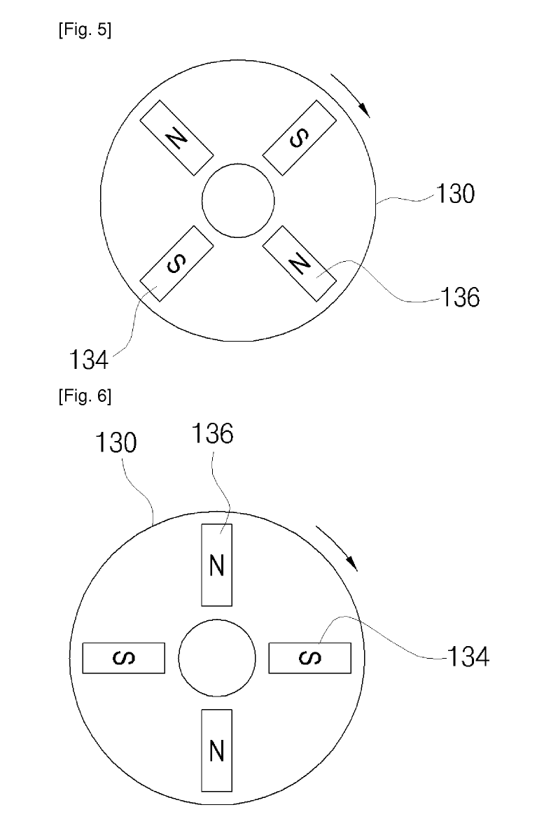

As shown in FIG. 5, the first and second upper magnets 134 and 136 are located between the first and second lower magnets 129 and 128 by rotation of the rotating plate 130. As described above, repulsive force exists between the first upper magnet 134 and first lower magnet 129 and between the second upper magnet 136 and second lower magnet 128. In this time, the first upper magnet 134 and second lower magnet 128 have different polarities from each other and the second upper magnet 136 and first lower magnet 129 have different polarities from each other. Accordingly, attraction force is generated between the first upper magnet 134 and second lower magnet 128, and between the second upper magnet 136 and first lower magnet 129. The attraction force helps the rotating plate 130 to rotate more easily. In other words, repulsive and attraction forces are simultaneously applied on the rotating plate 130.

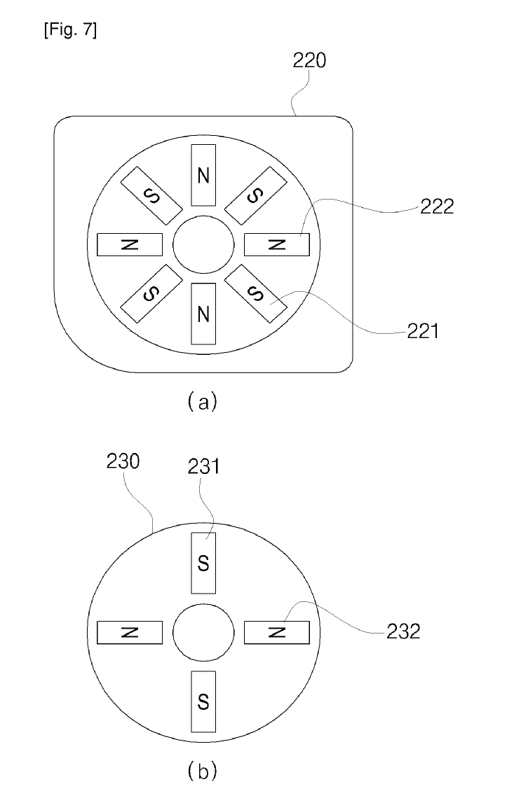

As shown in FIG. 6, when the rotating plate 130 is located at the second position, the first upper magnet 134 is located over the second lower magnet 128 and the second upper magnet 136 is located over the first lower magnet 129. As described above, attraction force is generated between the first upper magnet 134 and second lower magnet 128, and between the second upper magnet 136 and first lower magnet 129. The rotating plate 130 is kept at the second position by the attraction force.

In the embodiment, the first and second lower magnets 129 and 128 and first and second upper magnets 134 and 136 are arranged to be perpendicular to each other respectively and thus the rotating plate 130 has rotary displacement of 90° when it moves from the first position to the second position. However, the rotary displacement of the rotating plate 130 can be adjusted by changing arrangement of the first and second lower magnets 129 and 128 and first and second upper magnets 134 and 136.

In addition, a lower body (not shown) provided with a key pad (not shown) may be connected to the lower casing 120 and an upper body (not shown) provided with a display (not shown) may be connected to the rotating plate 130. As described above, the rotating plate 130 has rotary displacement of 90° and accordingly, the upper body provided with the display also has rotary displacement of 90°. Thus, the horizontal display can be converted into a vertical direction by rotation of the rotating plate 130.

On the other hand, the lower casing 120 includes a cam surface 124 and a cam groove 126 concaved from the cam surface 124. The cam surface 124 is located at the circumference of the first and second lower magnets 129 and 128 and projected from the upper surface of the lower casing 120. In addition, the rotating plate 130 includes a cam projection 132. The cam projection 132 is located at the circumference of the first and second upper magnets 134 and 136 and projected from the lower surface of the rotating plate 130. The cam groove 126 is located similarly to the angle (for example, 90°) between the first and second lower magnets 129 and 128. The cam projection 132 moves along the cam surface 124 in a state of being contacted to the cam surface 124 and is inserted into the cam groove 126 at the first and second positions, thereby preventing rotation of the rotating plate 130.

### MODE FOR THE INVENTION

FIG. 7 shows a swing hinge apparatus according to another embodiment of the present invention.

As shown in FIG. 7(a), first and second lower magnets 221 and 222 are arranged to be equiangular (for example, 45°) to each other about the center. In other words, the first lower magnets 221 are arranged to be equiangular (for example, 90°) to each other and the second lower magnets 222 are arranged to be equiangular (for example, 90°) to each other. The first and second lower magnets 221 and 222 are alternatively arranged. On the other hand, (first and second upper magnets 231 and 232 provided on a rotating plate 230 are arranged to be equiangular (for example, 90°) to each other about the center of the rotating plate 230. As described above, the first and second lower magnets 221 and 222 have different polarities from each other and the first upper magnet 231 has the same polarity as the first lower magnet 221 and the second upper magnet 232 has the same polarity as the second lower magnet 222.

When the first upper magnet 231 is located over the second lower magnet 222, the second upper magnet 232 is also located over the second lower magnet 222. In this time, repulsive force exists between the first upper magnet 231 and second lower magnet 222 and attraction force exists between the second upper magnet 232 and second lower magnet 222. In other words, when external force is not applied, the rotating plate 230 is kept in equilibrium state by the repulsive and attraction forces and the rotating plate 230 and lower casing 220 are kept in a state of being spaced from each other. Accordingly, it is possible to prevent friction between the rotating plate 230 and lower casing 220, and to secure semi-permanent lifetime.

On the other hand, when the rotating plate 230 is rotated by external force, the repulsive force between the first upper magnet 231 and first lower magnet 221 helps the rotating plate 230 to rotate.

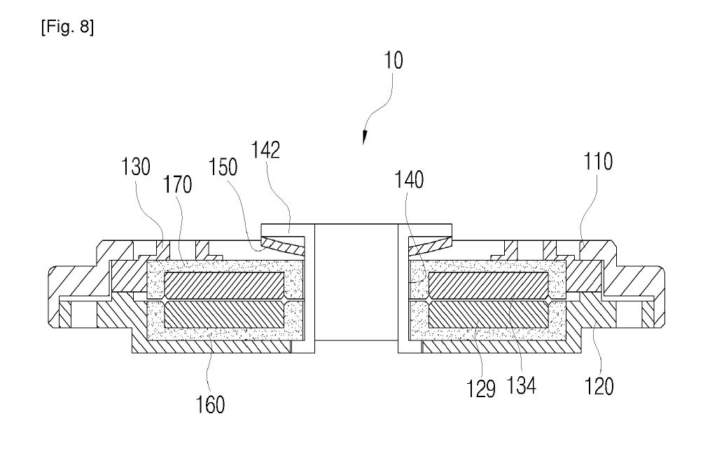

FIG. 8 shows a swing hinge apparatus according to a still another embodiment of the present invention. FIG. 8 shows a modification of the swing hinge apparatus of FIG. 3.

As shown in FIG. 8, the swing hinge apparatus further include lower and upper shielding members 160 and 170. The lower shielding member 160 is provided between the lower casing 120 and first and second lower magnets 129 and 128. The lower shielding member 160 surrounds the first and second lower magnets 129 and 128 respectively and prevents magnetic force generated by the first and second lower magnets 129 and 128 from being diffused toward the lower casing 120. Similarly, the upper shielding member 170 is provided between the rotating plate 130 and first and second upper magnets 134 and 136. The upper shielding member 170 surrounds the first and second upper magnets 134 and 136 respectively and prevents magnetic force generated by the first and second upper magnets 134 and 136 from being diffused toward the rotating plate 130.

### INDUSTRIAL APPLICABILITY

The present invention can be applied in various products including a cellular phone that requires swing function.

1. A swing hinge apparatus of a cellular phone, comprising:
a plurality of first and second lower magnets having polarities different from each other;
a lower casing, the first and second lower magnets being respectively inserted into one surface of the lower casing;
a plurality of first and second upper magnets having the same polarities as the first and second lower magnets respectively; and
a rotating plate provided over the lower casing, where the first and second upper magnets are respectively inserted into one surface thereof facing the lower casing.

2. The swing hinge apparatus of claim 1, wherein
the rotating plate moves to first and second positions by rotating and,
at the first position, the each first upper magnet is located over the each second lower magnet and the each second upper magnet is located over the each first lower magnet, and
at the second position, the each first upper magnet is located over the each first lower magnet and the each second upper magnet is located over the each second lower magnet.

3. The swing hinge apparatus of claim 1, wherein
the rotating plate moves to first and second positions by rotation and,
at the first position, the each first upper magnet is located over the each second lower magnet and the each second upper magnet is located over the each second lower magnet, and
at the second position, the each first upper magnet is located over the each first lower magnet and the each second upper magnet is located over the each first lower magnet.

4. The swing hinge apparatus of claim 1, wherein the first and second upper magnets are alternatively arranged to be equiangular to each other about a rotation center of the rotating plate and the first and second lower magnets are alternatively arranged to be equiangular to each other about the rotation center of the rotating plate.

5. The swing hinge apparatus of claim 1, further comprising an upper casing that is provided over the lower casing so as to surround the edge of the rotating plate.

6. The swing hinge apparatus of claim 1, further comprising:
a shaft, located at the rotation center of the rotating plate, connecting the rotating plate to the lower casing; and
an elastic body, provided on the shaft and above the rotating plate, providing elastic force toward the lower casing.

7. The swing hinge apparatus of claim 1, wherein
the lower casing comprises a cam surface and a plurality of cam grooves concaved from the cam surface, and
the rotating plate comprises a cam projection that moves along the cam surface and is inserted into any one of the cam grooves at the first and second positions.

8. The swing hinge apparatus of claim 1, further comprising:
a lower shielding member provided between the lower casing and the first and second lower magnets in order to shield magnetic force of the first and second lower magnets; and
an upper shielding member provided between the rotating plate and the first and second upper magnets in order to shield magnetic force of the first and second upper magnets.
